(19) United States
(12) Patent Application Publication
(10) Pub. No.: US 2017/0270575 A1
(43) Pub. Date: Sep. 21, 2017

(54) Method of Acquiring Services Through a Distributed Contractor Network

(71) Applicant: Diana Gacheri Muturia, Phoenix, AZ (US)

(72) Inventor: Diana Gacheri Muturia, Phoenix, AZ (US)

(21) Appl. No.: 15/462,648

(22) Filed: Mar. 17, 2017

Related U.S. Application Data
(60) Provisional application No. 62/309,848, filed on Mar. 17, 2016.

(51) Int. Cl. G06Q 30/06

(52) U.S. Cl. CPC G06Q 30/0601

(57) ABSTRACT

A method for acquiring services through a distributed contractor network enables a user to search for available contractors who are capable of satisfying a specific service request. The system has multiple networked contractor profiles and a user profile. The method is initiated when the user creates a service request. The next step in the method is to find a number of contractors who are best suited to satisfy the service request and then organize the contractors based on some predefined criteria. The method continues by presenting the organized list to the user so the user can choose a desired contractor. The user is then able to negotiate a service contract with the contractor. Upon job completion, the user visually inspects the contractor's work and then transmits payment to the contractor. To finish the method, the user rates the contractor's work so that other users know the contractor's performance.

The current application claims a priority to the U.S. Provisional Patent application Ser. No. 62/309,848 filed on Mar. 17, 2016.

### FIELD OF THE INVENTION

The present invention relates generally to the field of service-finding mobile applications. More specifically, the present invention is a method that enables a user to locate and commission a contractor to complete a desired task.

### BACKGROUND OF THE INVENTION

The traditional method for finding contractors rely on word of mouth. After phonebooks were invented, it became easy to locate contractors who could perform a certain task. While this was convenient, the phonebooks did not include ratings of the contractor's performance. This often lead to buyer's remorse for shoddy workmanship. With the advent of the internet and contractor finding platforms, it became easy to track a contractor's performance rating. These innovations improved the quality of contractor-user relationships and helped prevent buyer's remorse. While this was arguably a huge leap forward for the service industry, users still lacked the ability to easy locate and negotiate with multiple contractors in a single application.

The present invention addresses this shortcoming by providing method for creating a network of contractors from which a user can choose. The present invention enables a user so access a distributed network of contractors who are able to satisfy a wide range of service requests. Specifically, the present invention enables contractors to create digital profiles that display their skillsets. The present invention then enables the user to browse these digital profiles when searching for a contractor with a specific skillset. Furthermore, the present invention enables the user to negotiate multiple contracts with contractors without having to switch between several communication platforms. Finally, the present invention enables the user to choose the most qualified and highly rated contractor by presenting the user with ratings for each contractor on the network.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing a process for adjusting the desirability score of for each contractor profile based on the distance between the current contractor location and the desired service location.

FIG. 4 is a flowchart describing a process for adjusting the desirability score of for each contractor profile based on the similarities between the contractor's capable-skills description and the job description.

FIG. 5 is a flowchart describing a process for adjusting the desirability score of for each contractor profile based on the overall rating of each contractor profile.

FIG. 6 is a flowchart describing a process for populating the list of best-available profiles with contractor profiles that have desirability scores above the desirability threshold.

FIG. 7 is a flowchart describing a process for displaying the organized set of best-available profiles.

FIG. 8 is a flowchart describing a process for displaying a geographic representation of the set of best-available profiles.

FIG. 9 is a flowchart describing a process for sending and receiving information between the user account and the contractor profile during the negotiation process.

FIG. 10 is a flowchart describing a process for sending and receiving information between the user account and the contractor profile to generate a completion confirmation that satisfies the service contract.

FIG. 11 is a flowchart describing a process for rating a contractor profile after a service contract has been completed.

### DETAIL DESCRIPTIONS OF THE INVENTION

All illustrations of the drawings are for the purpose of describing selected versions of the present invention and are not intended to limit the scope of the present invention.

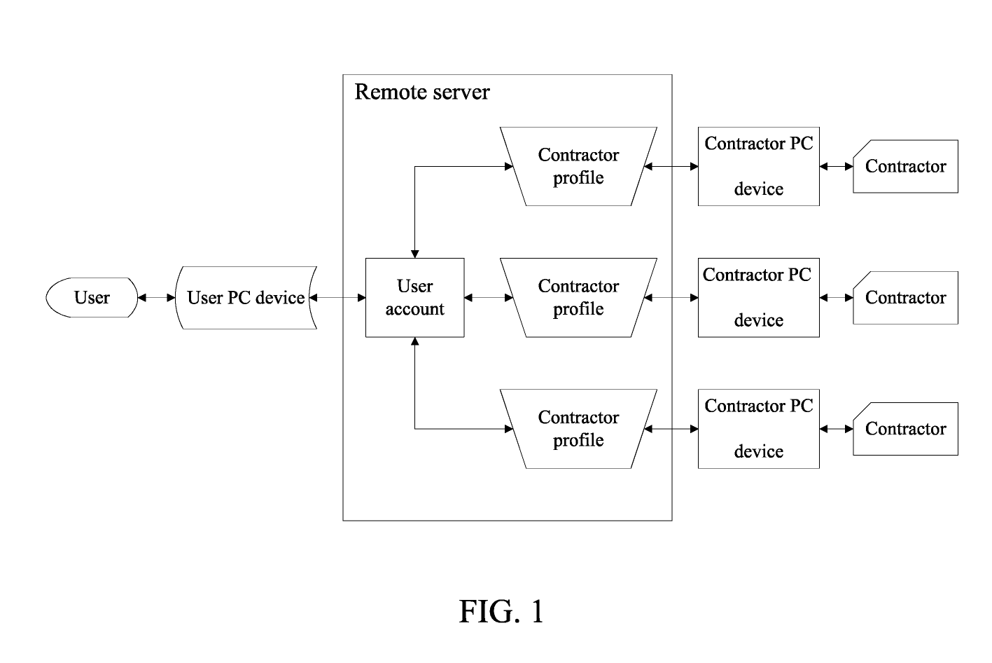

As can be seen in FIG. 1 through FIG. 11, the present invention is a method for acquiring services through a distributed contractor network. Additionally, the present invention enables a consumer to find and request the services of contractors. A user of the present invention will be able to search through a network of contractors who are able to perform a given service at a desired time, price point, and geographic location. In addition to finding available contractors, the present invention uses location, price, and user ratings to rank each contractor that is associated with a contractor profile. In this way, the present invention enables the user to have the confidence that any contractor they hire through the present invention will do the job well. The present invention also enables the user to send pictures and videos of a specific job to be completed. This functionality gives the contractor a clear understanding of the scope of work. Once the contractor has completed a specific job, the present invention is designed to enable the contractor to send a picture or video of the completed job. This enables the user to visually inspect the job from a remote location. In the present invention, the contractor profile enables the contractor to not only receive notifications from users who have transmitted service requests, but to also browse all the available service requests in a given area. This enables the contractor to find work by messaging users whose service requests have not been satisfied.

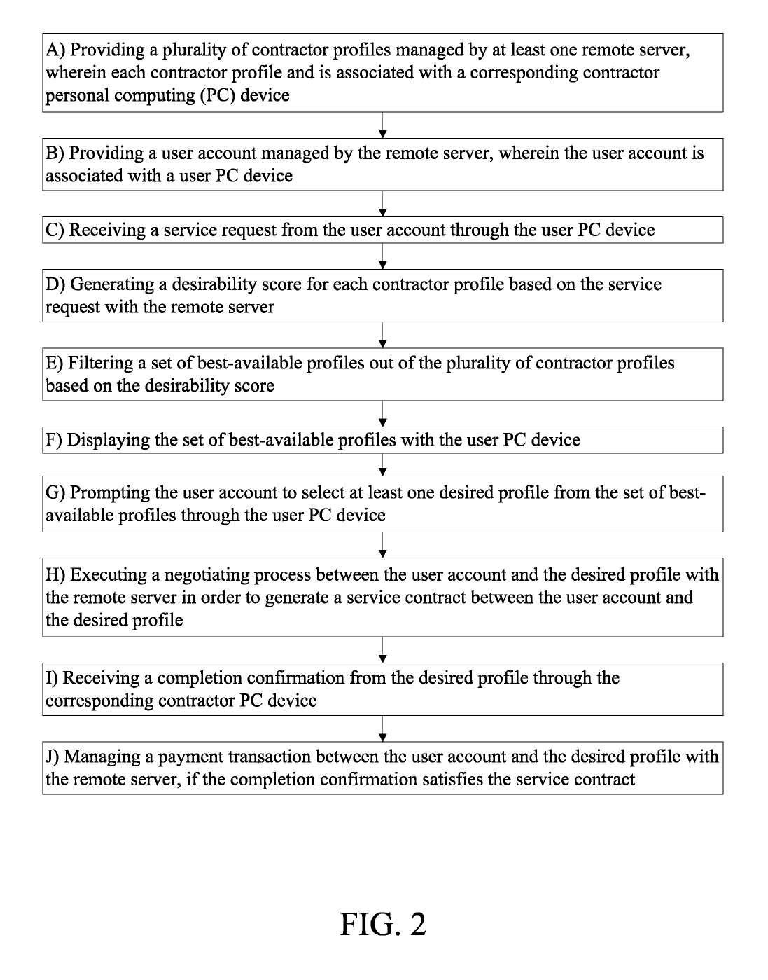

As can be seen in FIG. 1 through FIG. 2, the system used to execute the method of the present invention allows the present invention to manage a large number of contractors. Consequently, the present invention identifies each contractor with a unique contractor profile that is one of a plurality of contractor profiles. The contractor profile enables the present invention to maintain a record of the contractor's skillset, current location, user rating, and various other pieces of business information that pertains to providing services. The present invention includes at least one remote server to manage the plurality of contractor profiles, each of which is associated with a corresponding contractor personal computing (PC) device (Step A). The corresponding contractor PC device is used to receive input from a contractor and is used to relay information between the remote server and the contractor. Additionally, the system used to execute the method of the present invention allows the present invention to interact with a user who is searching for a contractor to perform a specific service. As a result, the present invention identifies the user with a unique user account that is managed by the remote server and associated with a user PC device (Step B). The user account enables the present invention to maintain a record of the user's preferred contractors, payment information, other personal information. The user PC device is used to receive input from a user and is used to relay information between the remote server and the user. The corresponding contractor PC device and the user PC device can be, but are not limited to, a smart-phone, a laptop, a desktop PC, or a tablet PC. The remote server is used to execute a number of internal processes for the present invention and is used to store personal preferences for each of the plurality of contractor accounts and the user account.

As can be seen in FIG. 2, the overall process followed by the method of the present invention allows a user to search for contractors, negotiate contracts to complete a specific job, and to transfer payment to the contractor upon completion of the specific job. As such, the overall process begins by receiving a service request from the user account through the user PC device (Step C). The service request is a message that is created by the user through the corresponding user PC device and transmitted to the remote server. The service request contains information that specifies the type of job that the user wishes to have completed, the amount that the user would like to pay for a specific service, and the location of the job to be completed. The service request is the user's way of querying the present invention for contractors who are capable of performing a desired service. The overall process of the present invention continues by generating a desirability score for each contractor profile based on the service request with the remote server (Step D). This step is used to determine the contractor profiles that are most-likely able to satisfy the service request. The desirability score is a rating that indicates how closely the information in a contractor profile aligns with the information provided by the user in the service request. For example, if a user searches for a house cleaner in Fresno, Calif., the present invention will calculate a higher desirability score for a contractor offering housecleaning services in Fresno, Calif. than a contractor offering housecleaning services in Denver, Colo.

As can be seen in FIG. 2, the overall process of the present invention continues by filtering a set of best-available profiles out of the plurality of contractor profiles based on the desirability score with the remote server (Step E). This step is used to form a ranked list of contractor profiles who are able to satisfy the service request. The set of best-available profiles is a list that contains the contractor profiles which have a desirability score that is greater than or equal to a predetermined threshold. Additionally, the set of best-available profiles is arranged in descending order, with the contractor having the highest desirability score appearing as the first entry in the set of best-available profiles. The overall process of the present invention continues by displaying the set of best-available profiles with the user PC device (Step F). This step is used to relay a graphical representation of the information obtained in Step E to the user.

As can be seen in FIG. 2, the overall process of the present invention continues by prompting the user account to select at least one desired profile from the set of best-available profiles through the user PC device (Step G). This step is used to enable the user to select the contractor or contractors who seem like a fit for the user's service request. The desired profile is a contractor profile that the user decides to negotiate a service contract with. For example, if the set of best-available profiles includes profiles for contractor A, contractor B, and contractor C, the user is able to select contractor B as the profile which the user believes will best satisfy the service request. The overall process continues by executing a negotiating process between the user account and the desired profile with the remote server in order to generate a service contract between the user account and the desired profile (Step H). This step is used to enable the user to communicate with the contractor in order to arrive at a mutually beneficial agreement on how the service request should be satisfied. The negotiation process includes a series of sub-processes that enable the user and the contractor to fully define and agree upon a scope of work and a fee that the contractor will charge to complete said scope of work. The service contract is an agreement between the user and the contractor that defines when and how the service request will be satisfied.

As can be seen in FIG. 2, the overall process of the present invention continues by receiving a completion confirmation from the desired profile through the corresponding contractor PC device (Step I). This step is used to alert the user that the contractor has completed the work outlined in the service contract. The completion confirmation is a message that includes information requesting the user inspect the completed work. The user then is able work with the contractor to make any modifications to the job until the user determines the service request is satisfied. The overall process of the present invention concludes by managing a payment transaction between the user account and the desired profile with the remote server, if the completion confirmation satisfies the service contract (Step J). This step is used to transfer a previously agreed upon sum of money from the user to the contractor. The payment transaction is a process where the user is able to select the financial account that will be used to pay the contractor for the completed job. For example, if the user has multiple credit cards that are associated with the user account, the user is able to choose the desired credit card to pay the contractor. A separate sub-process lets the user rate the contractor's performance.

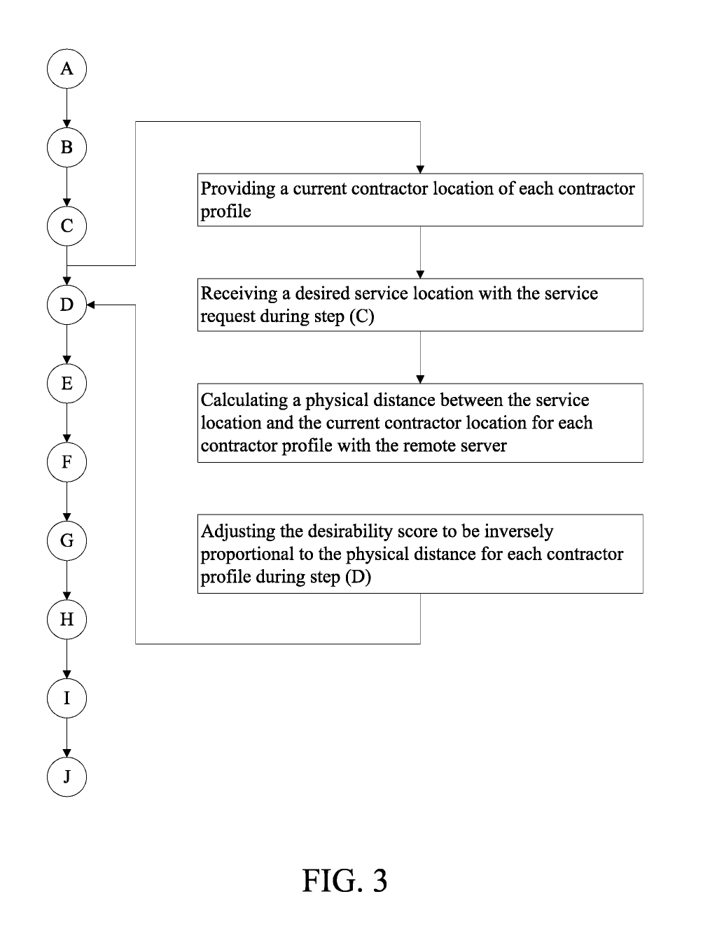

As can be seen in FIG. 3, a sub-process of the method of the present invention is used to adjust the desirability score of each contractor profile based on the current contractor location of the contractor. The sub-process begins by receiving a desired service location with the service request during Step C. This step is used to isolate the piece of information within the service request that dictates the location of a job to be completed. The desired service location is the geographic location of the job that the user is searching for a contractor to complete. The sub-process continues by calculating a physical distance between the desired service location and the current contractor location for each contractor profile with the remote server. This step uses the physical distance between the desired service location and each contractor's current location to adjust the desirability score of each contractor profile. By comparing the desired service location to the current location of every contractor profile, the present invention is able to determine which contractor profiles are below the desirability threshold and should not be included in the set of best-available profiles. The sub-process concludes by adjusting the desirability score to be inversely proportional to the physical distance for each contractor profile during Step D. Preferably, the desirability score is inversely proportional to the distance between the desired service location and the current contractor location. This enables the present invention to determine which contractors would be best able to satisfy the service request. For example, a contractor that is three miles away from the desired service location will receive a higher desirability score than a contractor that is twenty miles away from the desired service location.

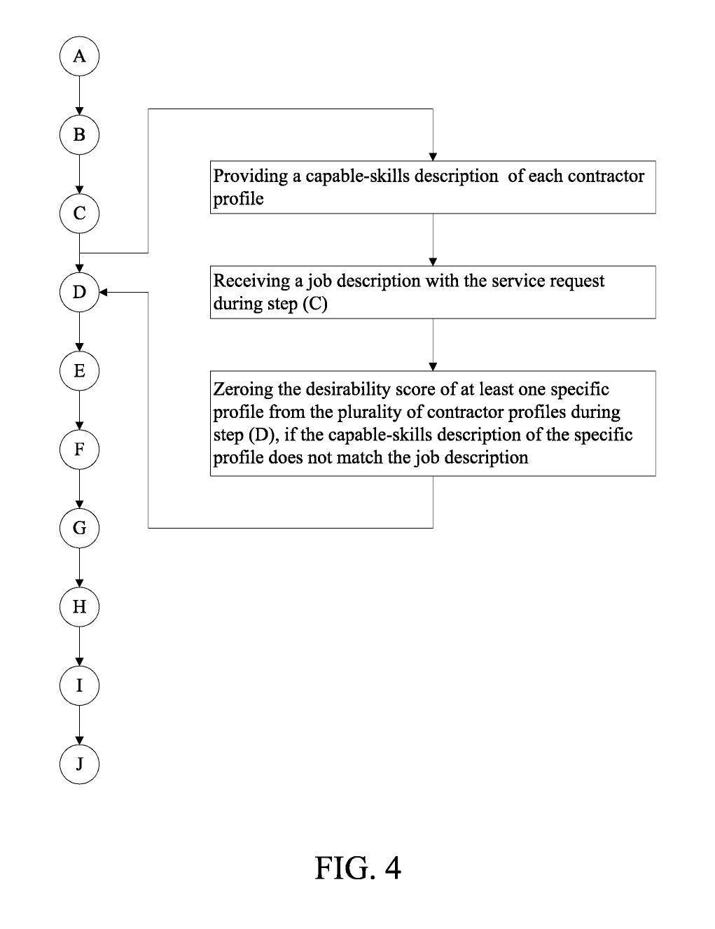

As can be seen in FIG. 4, a sub-process of the method of the present invention is used to adjust the desirability score of each contractor profile based on the capable-skills description of the contractor profile. The capable-skills description is an attribute of each contractor profile that describes the types of service requests that each contractor is capable of completing. The sub-process begins by receiving a job description with the service request during Step C. This step is used to isolate the piece of information within the service request that dictates the description of a job to be completed. The sub-process continues by zeroing the desirability score of at least one specific profile from the plurality of contractor profiles during Step D, if the capable-skills description of the specific profile does not match the job description. This step is used to make the desirability score of a contractor profile less than the desirability threshold, if the contractor is not able to satisfy the service request. For example, if the user searches for plumbers, then a contractor that performs roofing jobs will receive a desirability score that is zero, while a contractor that performs plumbing jobs will receive a desirability score that is greater than zero. This enables the present invention to determine which contractors would be best able to satisfy the service request and should be included in the set of best available profiles.

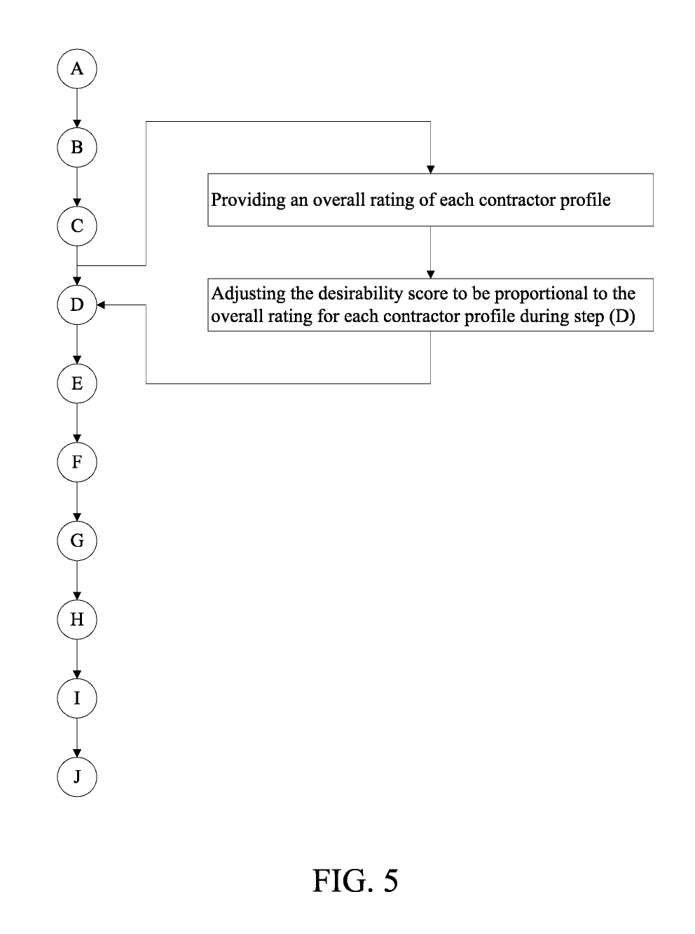

As can be seen in FIG. 5, a sub-process of the method of the present invention is used to adjust the desirability score of each contractor profile based on the overall rating of the contractor profile. The overall rating is an aggregated score that reflects how other users have rated each contractor for services rendered in the past. The sub-process simply adjusts the desirability score to be proportional to the overall rating for each contractor profile during Step D. This step is used to ensure a highly-rated contractor is presented to the user before a lowly-rated contractor. For example, if contractor A and contractor B are both plumbers and are located 3 miles from a desired plumbing job and contractor a has a higher overall rating, then contractor a will be ranked higher in the set of best-available profiles.

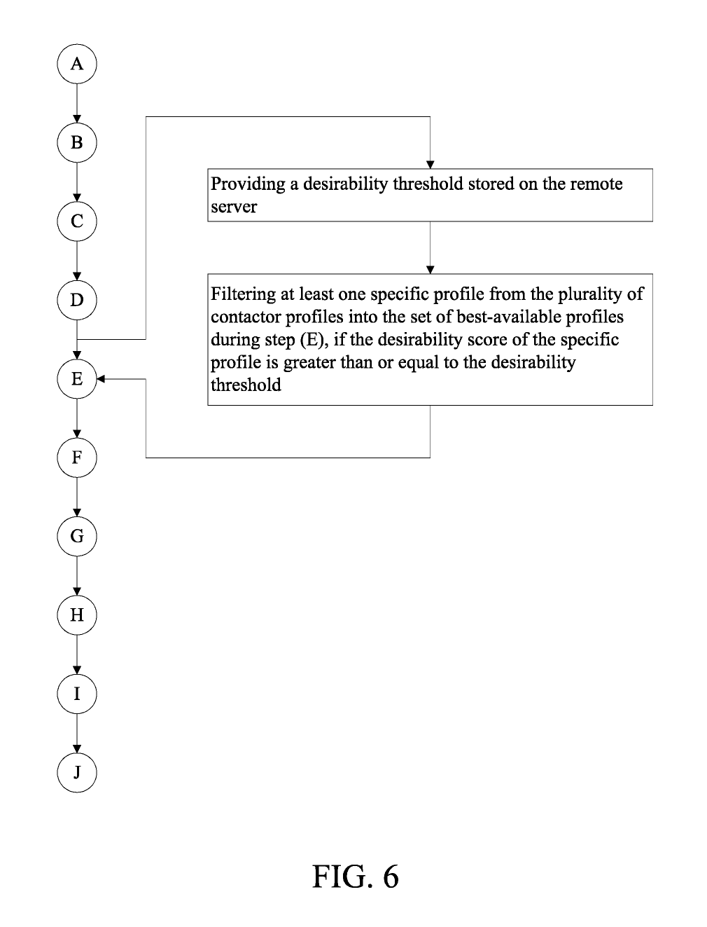

As can be seen in FIG. 6, a sub-process of the method of the present invention uses the desirability threshold to limit the number of contractor profiles that are presented to a user in response to a service request. The desirability threshold is a predefined number that is used to determine if a contractor is worth considering to complete a service request. The sub-process simply filters at least one specific profile from the plurality of contactor profiles into the set of best-available profiles during Step E, if the desirability score of the specific profile is greater than or equal to the desirability threshold. This step is used to ensure that only highly desirable contractors are presented to the user in response to the service request.

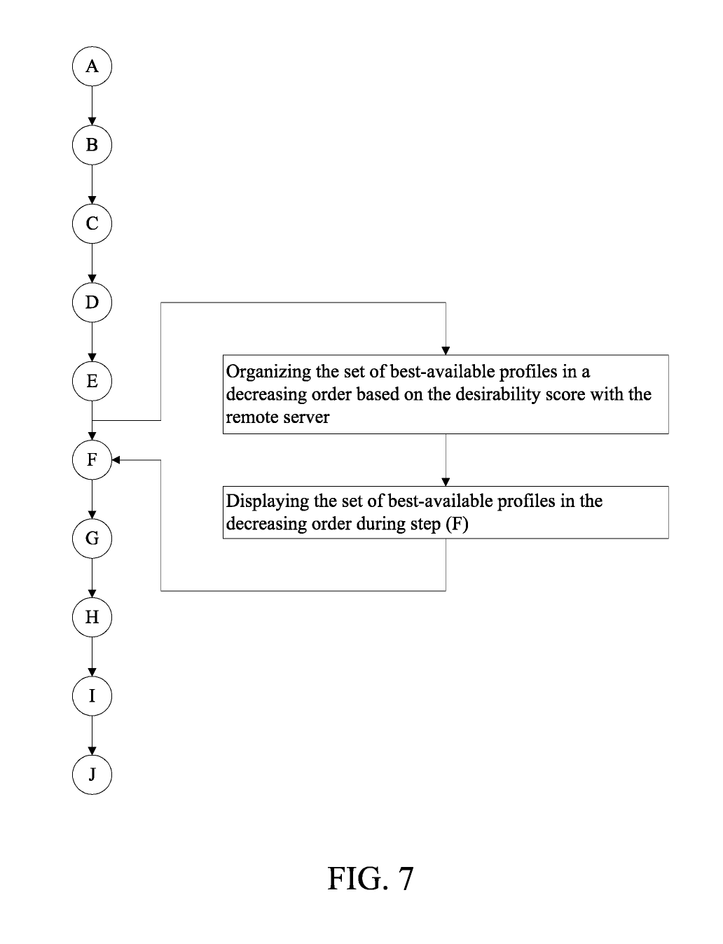

As can be seen in FIG. 7, a sub-process of the method of the present invention uses the desirability score to organize each of the contractor profiles that are included in the set of best-available profiles. The sub-process begins by organizing the set of best-available profiles in a decreasing order based on the desirability score with the remote server. This step is used to arrange the set of best-available profiles in a manner that facilitates finding the best service. The sub-process concludes by displaying the set of best-available profiles in the decreasing order during Step F. This step is used to present the results of the query to the user in a highly structured, yet readable, format.

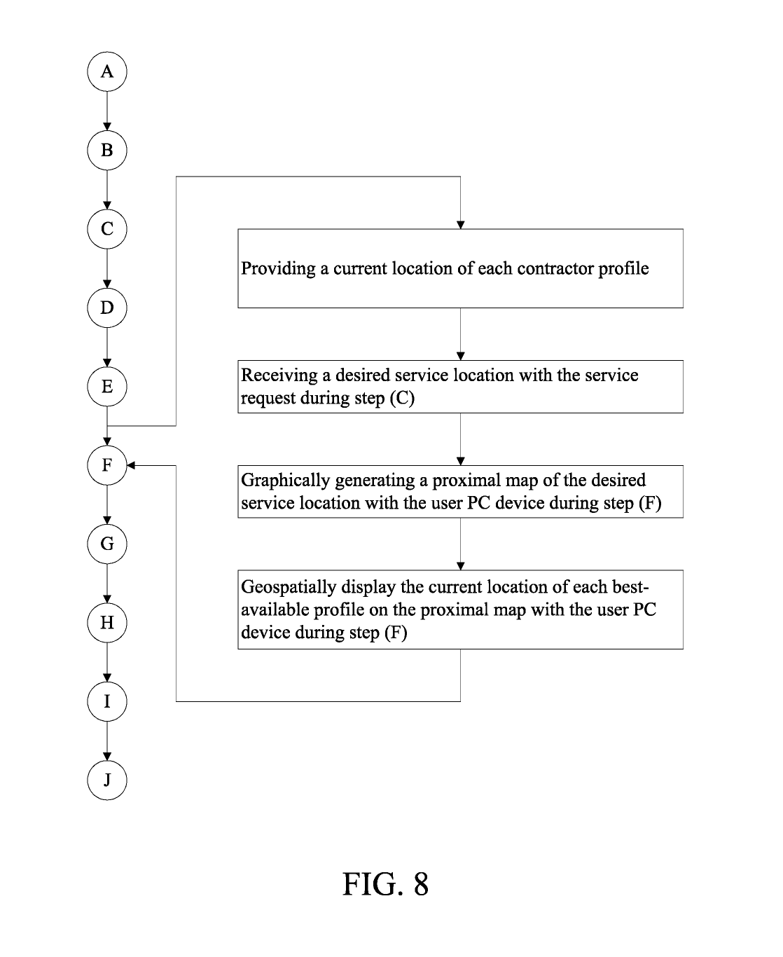

As can be seen in FIG. 8, a sub-process of the method of the present invention uses the current contractor location and the desired service location to render a map of the contractors in a given area. This sub-process begins by receiving a desired service location with the service request during Step C. As described earlier, so that the present invention has a center reference point against which to compare the current contractor location of each contractor profile. The sub-process continues by graphically generating a proximal map of the desired service location with the user PC device during Step F. This step is used to represent the desired service location as a point on a geographical map. The sub-process concludes by geospatially displaying the current location of each best-available profile on the proximal map with the user PC device during Step F. As a result, the user is presented with an image that shows the location of each contractor profile included in the set of best-available profiles.

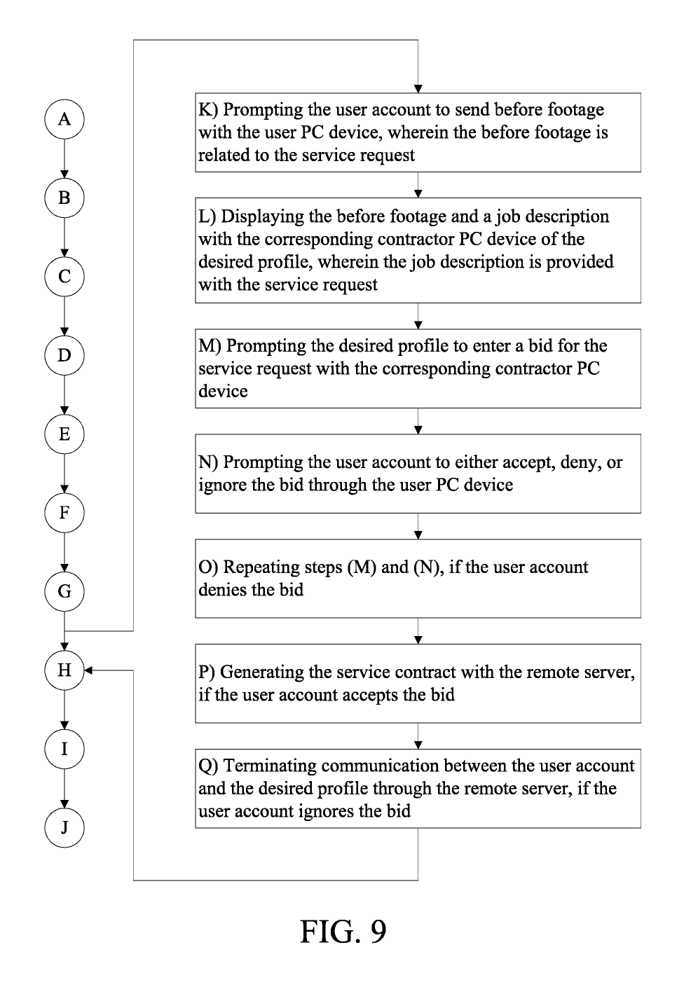

As can be seen in FIG. 9, a sub-process of the method of the present invention is used to execute the negotiating process. This sub-process enables the user to communicate with contractors while searching for the best contractor to complete the service request. The sub-process begins by prompting the user account to send before footage with the user PC device (Step K). The before footage is a picture or video showing the task that the service request was created to have completed. For example, if a user wants to have a room painted, the user will send photos or videos that show the unpainted room. This gives contractors an idea of what the scope of work is. The sub-process continues by displaying the before footage and a job description with the corresponding contractor PC device of the desired profile (Step L). Once the user has selected a desired profile from the set of best-available profiles, the job description and the before footage is transferred to the contractor. This initiates communication between the user and the contractor based on information that was included in the service request. The sub-process continues by prompting the desired profile to enter a bid for the service request with the corresponding contractor PC device (Step M). The bid is a message that the contractor sends to the user which contains the estimate of what the contractor will charge to complete the task identified in the job description. However, the bid is capable of containing other information such as a message requesting more information from the user. The sub-process continues by prompting the user account to either accept, deny, or ignore the bid through the user PC device (Step N). This step is used to let the user respond to the bid made by the contractor. The response by the user can ask for a lower price, or modify the job description to account for recommendations made by the contractor. The process continues by repeating Step M and Step N, if the user account denies the bid (Step 0). This step lets the user and the contractor negotiate the service contract in a back-and-forth manner that is mutually beneficial. The sub-process continues by generating the service contract with the remote server, if the user account accepts the bid (Step P). The service contract defines the scope of work, the completion timeline and the price to be paid upon task completion. A separate option for the sub-process terminates communication between the user account and the desired profile through the remote server, if the user account ignores the bid (Step Q). This option lets the user break off negotiations with the contractor at any time.

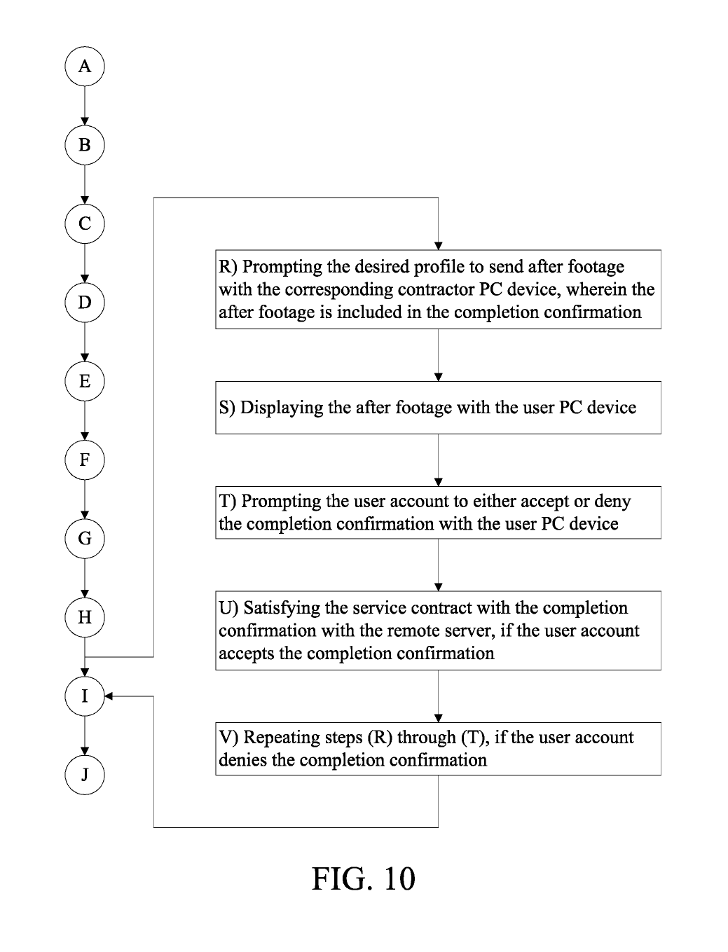

As can be seen in FIG. 10, a sub-process of the method of the present invention is executed when a completion confirmation is generated. This sub-process enables the user to inspect the work of the contractor prior to paying for a completed job. The sub-process begins by prompting the desired profile to send after footage with the corresponding contractor PC device (Step R). The after footage is a video or photo that the shows the completed job. The contractor sends the completion confirmation to the user so that the user is notified of the completed job and is therefore ready to transfer payment. The sub-process continues by displaying the after footage with the user PC device (Step S). This step enables the user to visually inspect the contractor's work. The sub-process continues by prompting the user account to either accept or deny the completion confirmation with the user PC device (Step T). This step is used to enable the user to direct the contractor to perform additional tasks if the user feels the service contract has not been satisfied. The sub-process continues by satisfying the service contract with the completion confirmation with the remote server, if the user account accepts the completion confirmation (Step U). To satisfy the service contract, the contractor must perform the additional tasks that the user indicates. Once this is complete, the contractor transmits another completion confirmation. As such, the sub-process continues by repeating Step R through Step T, if the user account denies the completion confirmation (Step V). This enables the user and the contractor to work together until work done by the contractor satisfies the agreed upon service contract.

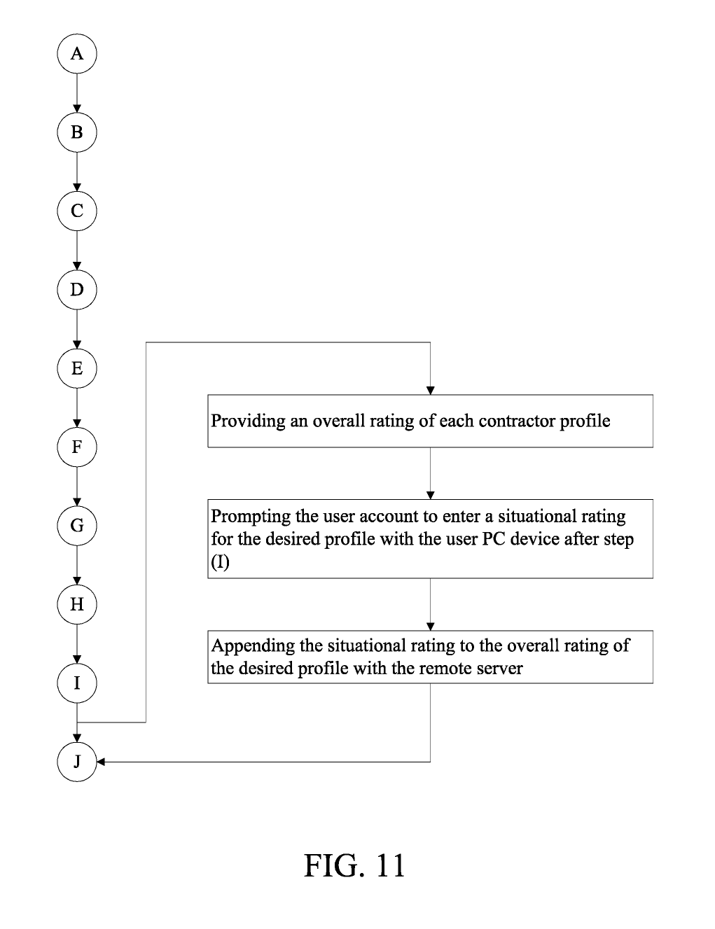

As can be seen in FIG. 11, a sub-process of the method of the present invention is executed when the payment transaction is initiated. This process enables the user to rate the contractor's work, thus affecting the contractor's overall rating. The sub-process begins by prompting the user account to enter a situational rating for the desired profile with the user PC device after Step I. The situational rating is the user's rating of the contractor's work that is used to adjust the contractor's overall rating and, thus, the contractor's desirability score. The sub-process concludes by appending the situational rating to the overall rating of the desired profile with the remote server. This step is used to modify the contractor's overall rating to reflect the situational rating. Over time many situational ratings add up to create the overall rating.

Although the invention has been explained in relation to its preferred embodiment, it is to be understood that many other possible modifications and variations can be made without departing from the spirit and scope of the invention as hereinafter claimed.

What is claimed is:

1. A method of acquiring services through a distributed contractor network, the method comprises the steps of:
(A) providing a plurality of contractor profiles managed by at least one remote server, wherein each contractor profile and is associated with a corresponding contractor personal computing (PC) device;
(B) providing a user account managed by the remote server, wherein the user account is associated with a user PC device;
(C) receiving a service request from the user account through the user PC device;
(D) generating a desirability score for each contractor profile based on the service request with the remote server;
(E) filtering a set of best-available profiles out of the plurality of contractor profiles based on the desirability score with the remote server;
(F) displaying the set of best-available profiles with the user PC device;
(G) prompting the user account to select at least one desired profile from the set of best-available profiles through the user PC device;
(H) executing a negotiating process between the user account and the desired profile with the remote server in order to generate a service contract between the user account and the desired profile;
(I) receiving a completion confirmation from the desired profile through the corresponding contractor PC device, and
(J) managing a payment transaction between the user account and the desired profile with the remote server, if the completion confirmation satisfies the service contract.

2. The method of acquiring services through a distributed contractor network, the method as claimed in claim 1 comprises the steps of:
providing a current contractor location of each contractor profile;
receiving a desired service location with the service request during step (C);
calculating a physical distance between the desired service location and the current contractor location for each contractor profile with the remote server, and
adjusting the desirability score to be inversely proportional to the physical distance for each contractor profile during step (D).

3. The method of acquiring services through a distributed contractor network, the method as claimed in claim 1 comprises the steps of:
providing a capable-skills description of each contractor profile;
receiving a job description with the service request during step (C), and
zeroing the desirability score of at least one specific profile from the plurality of contractor profiles during step (D), if the capable-skills description of the specific profile does not match the job description.

4. The method of acquiring services through a distributed contractor network, the method as claimed in claim 1 comprises the steps of:
providing an overall rating of each contractor profile, and
adjusting the desirability score to be proportional to the overall rating for each contractor profile during step (D).

5. The method of acquiring services through a distributed contractor network, the method as claimed in claim 1 comprises the steps of:
providing a desirability threshold stored on the remote server, and
filtering at least one specific profile from the plurality of contactor profiles into the set of best-available profiles during step (E), if the desirability score of the specific profile is greater than or equal to the desirability threshold.

6. The method of acquiring services through a distributed contractor network, the method as claimed in claim 1 comprises the steps of:
organizing the set of best-available profiles in a decreasing order based on the desirability score with the remote server, and
displaying the set of best-available profiles in the decreasing order during step (F).

7. The method of acquiring services through a distributed contractor network, the method as claimed in claim 1 comprises the steps of:
providing a current location of each contractor profile;
receiving a desired service location with the service request during step (C);
graphically generating a proximal map of the desired service location with the user PC device during step (F), and
geospatially display the current location of each best-available profile on the proximal map with the user PC device during step (F).

8. The method of acquiring services through a distributed contractor network, the method as claimed in claim 1 comprises the steps of:
(K) prompting the user account to send before footage with the user PC device, wherein the before footage is related to the service request;
(L) displaying the before footage and a job description with the corresponding contractor PC device of the desired profile, wherein the job description is provided with the service request;
(M) prompting the desired profile to enter a bid for the service request with the corresponding contractor PC device;
(N) prompting the user account to either accept, deny, or ignore the bid through the user PC device;
(O) repeating steps (M) and (N), if the user account denies the bid;
(P) generating the service contract with the remote server, if the user account accepts the bid, and (Q) terminating communication between the user account and the desired profile through the remote server, if the user account ignores the bid.

9. The method of acquiring services through a distributed contractor network, the method as claimed in claim 1 comprises the steps of:
(R) prompting the desired profile to send after footage with the corresponding contractor PC device, wherein the after footage is included in the completion confirmation;
(S) displaying the after footage with the user PC device;
(T) prompting the user account to either accept or deny the completion confirmation with the user PC device;
(U) satisfying the service contract with the completion confirmation with the remote server, if the user account accepts the completion confirmation, and (V)repeating steps (R) through (T), if the user account denies the completion confirmation.

10. The method of acquiring services through a distributed contractor network, the method as claimed in claim 1 comprises the steps of:
providing an overall rating of each contractor profile;
prompting the user account to enter a situational rating for the desired profile with the user PC device after step (I), and appending the situational rating to the overall rating of the desired profile with the remote server.
